(19) United States
(12) Patent Application Publication
(10) Pub. No.: US 2024/0158102 A1
(43) Pub. Date: May 16, 2024

(54) ATMOSPHERE REENTRY AND LANDING DEVICE FOR A ROCKET STAGE AND METHOD FOR THE REENTRY OF A ROCKET STAGE INTO THE ATMOSPHERE

(71) Applicant: SEBASTIAN KLAUS, HUEGELSHEIM (DE)

(72) Inventor: SEBASTIAN KLAUS, HUEGELSHEIM (DE)

(21) Appl. No.: 18/283,000

(22) PCT Filed: Mar. 11, 2022
(86) PCT No.: PCT/EP2022/025099

§ 371 Date: Sep. 20, 2023

(30) Foreign Application Priority Data
Mar. 22, 2021 (DE) 10 2021 106 981.5

(51) Int. Cl. B64G 1/00; B64G 1/22; B64G 1/62

(52) U.S. Cl. CPC B64G 1/006; B64G 1/2225; B64G 1/623

(57) ABSTRACT

An atmosphere reentry and landing device for a safe reentry of a rocket stage into the atmosphere and for a safe splashdown thereof. The device includes a ballute which is folded in a first state and unfolded in a second state, a shrouding mechanism which carries out a shrouding of the rocket stage with the ballute, a filling mechanism, and a control unit which controls the shrouding mechanism and the filling mechanism. The ballute is disposed on the rocket stage so that an aerodynamics thereof is not compromised in the first state. The ballute substantially shrouds the rocket stage in the second state. During reentry into the atmosphere, the filling mechanism fills the ballute in the second state with air or a gas from a boundary layer which is created between a plasma formed in front of a surface of the device and the surface of the device.

### CROSS REFERENCE TO PRIOR APPLICATIONS

This application is a U.S. National Phase application under 35 U.S.C. § 371 of International Application No. PCT/EP2022/025099, filed on Mar. 11, 2022 and which claims benefit to German Patent Application No. 10 2021 106 981.5, filed on Mar. 22, 2021. The International Application was published in German on Sep. 29, 2022 as WO 2022/199886 A1 under PCT Article 21(2).

### FIELD

The present invention relates to an atmosphere reentry and landing device for a rocket stage for the safe reentry into the atmosphere and for the safe splashdown of the rocket stage, and to a method for the reentry of a rocket stage into the atmosphere.

### BACKGROUND

The rocket industry has in recent years experienced a huge boom, in particular due to developments by companies in the private sector. As a result of various technical refinements, a significant reduction in costs for individual launches has been achieved. The global trend herein is towards reusable rockets.

Prior to being able to land rocket stages again by means of an engine, alternative methods were developed and to some extent used to safely return rocket stages to earth. For the reentry of a rocket stage, U.S. Pat. No. 3,508,724, which was filed in 1967, describes that a balloon filled with hot air be provided on the rocket tip. The rocket stage splashes down with the engines ahead; a second stage of the rocket cannot be re-used. U.S. Pat. No. 3,286,951 from 1963 describes a combination of an inflatable heat shield and a balloon. The balloon is filled with gas from a pressurized tank which is carried onboard. The heat shield shields part of the rocket in the direction of flight in the process. The rocket enters the atmosphere with the engine ahead, the latter being shielded by the heat shield. U.S. Pat. No. 4,504,031 from 1985 describes an inflatable braking means, whereby the engines of the rocket are used to generate a cool airstream in front of the inflatable braking means. This rocket thus also flies with the engines ahead when re-entering. Special pressurized tanks are moreover carried onboard. The rocket is not completely shrouded by the shield.

US 2016/0264266 A1 describes a reentry vehicle which can either return a payload or passengers back to the surface of the planet. The reentry vehicle comprises an aeroshell which can be unfolded and is covered with a heat-resistance woven fabric and has inflatable reinforcement elements. Stored energy in various forms is used for unfolding the aeroshell.

In 2012, SpaceX undertook initial tests for relanding a booster stage of Falcon 9. These efforts were met with success for the first time in December 2015. SpaceX has in the meantime successfully landed and reused several booster stages. The current record stands at nine flights using the same booster stage. This leads to a significant reduction in costs for a rocket launch.

When landing the booster stages of Falcon 9 and of Falcon Heavy, a single central engine of the total of nine engines of the rockets in the booster stage is used in each case. One issue associated with the landing is thus reliability; if a crash occurs, there is inevitably an explosion during the crash because the rockets' tanks are filled with highly flammable kerosene and liquid oxygen. For landing, SpaceX uses floating landing platforms (“autonomous spaceport drone ships”) and landing zones on firm ground within military properties. Perfecting the landing on a floating platform has taken more than three years of development work with quite a number of failures, and is technically highly complex. In this respect, the successes achieved by Elon Musk's SpaceX are a masterpiece.

However, the issue of price pressure, or the requirement of reusability, respectively, exists not only in the context of large and heavy rockets which can carry a high payload. Those rockets that land again by means of an engine become very heavy and thus lack performance due to the technology used for landing. The technology applied is not scalable and can be meaningfully applied only in rockets of medium to large size. The technology cannot moreover render the entire rocket reusable, but only the booster stage, i.e., the lower half. The orbital stage is not reused but is incinerated when reentering the atmosphere.

The performance of rockets is determined by the ideal rocket equation, also referred to as the Tsiolkovsky rocket equation. This equation teaches that the velocity which can be attained by a rocket is a function of the mass at the launch and the mass at the burnout of the rocket: v(m)=vₑ·In(m/m₀)

Here, v(m) is the velocity of the rocket as a function of the mass m, vₑ is the exhaust velocity of the gases of the engines, m is the mass of the rocket at the burnout, and m₀ is the mass of the rocket at launch.

In simple words, this means that the booster stages of SpaceX cannot reach such high velocities because they carry too much extra weight, for example, the weight of the landing legs, the weight of the control surfaces on the upper part of the rocket, the weight of the fuel for rotation in space and for deceleration prior to entering the atmosphere, and of course, the weight of the fuel required for landing.

The smaller the rocket, the less the scope for additional weight typically is before the rocket is no longer able to reach any orbit in space at all. In the case of so-called microlaunchers, of which dozens are currently being developed in order to launch large numbers of microsatellites, it is assumed that the technology of SpaceX cannot be applied because it is too heavy. The technology cannot accordingly be scaled and thus cannot be applied by all users, but remains restricted to large and expensive rockets. Reuse also has its limits in the known reuse technology: rockets typically fly very fast; typical velocities of a booster stage are approximately 8000 km/h, while the velocity of an orbital stage during orbit is at least 28,000 km/h. The rocket stages utilize the air resistance of the atmosphere for deceleration; only a small part is decelerated by reigniting the rocket engines. In booster stages such as those of SpaceX, the air is heated to several hundred degrees in the process, causing the typically burnt external appearance when landing. The air in orbital stages is in contrast heated up to a plasma because the energy generated increases in proportion to the square of the velocity. A rocket that enters the atmosphere without any external protection is incinerated and breaks up in this plasma flow. For this reason, the technology of SpaceX can be utilized for reuse only in booster stages which fly relatively slowly. The fast-flying orbital stages continue to be destroyed after single use.

### SUMMARY

An aspect of the present invention is to render rocket stages reusable, specifically booster stages and likewise orbital stages. An aspect of the present invention is moreover to be able to use the technology of the present invention also in large and heavy rockets as in microlaunchers without excessively restricting the payload scope. The technology to be developed is thereby to be reliable and easy to manage.

In an embodiment, the present invention provides an atmosphere reentry and landing device for a rocket stage for a safe reentry of the rocket stage into an atmosphere and for a safe splashdown of the rocket stage. The atmosphere reentry and landing device includes a ballute which is configured to be folded in a first state and to be unfolded in a second state, a shrouding mechanism which is configured to carry out a shrouding of the rocket stage with the ballute, a filling mechanism, and a control unit which is configured to control the shrouding mechanism and the filling mechanism. In the first state where the ballute is folded, the ballute is configured to be disposed on the rocket stage so that an aerodynamics of the rocket stage is not compromised by the ballute. In the second state where the ballute is unfolded, the ballute is configured to substantially shroud the rocket stage. During a reentry into the atmosphere, the filling mechanism is configured to fill the ballute in the second state where the ballute is unfolded with air or a gas from a boundary layer which is created between a plasma formed in front of a surface of the atmosphere reentry and landing device during the reentry and the surface of the atmosphere reentry and landing device.

### BRIEF DESCRIPTION OF THE DRAWINGS

The present invention is described in greater detail below on the basis of embodiments and of the drawings in which:

FIG. 1 schematically illustrates a launch and reentry of the atmosphere reentry and landing device according to the present invention into the atmosphere with a subsequent splashdown;

FIG. 2 schematically illustrates an atmosphere reentry and landing device in a plurality of views, including a filling mechanism for filling the ballute with air from a boundary layer between the plasma and the surface of the reentry body;

FIG. 3 schematically illustrates a shrouding mechanism according to the present invention;

FIG. 4 illustrates different types of air inlets for a filling mechanism;

FIG. 5 schematically illustrates fastenings of a ballute; and

FIG. 6 shows a flow chart of a method according to the present invention for the reentry of a rocket stage into the atmosphere.

### DETAILED DESCRIPTION

A first aspect of the present invention relates to an atmosphere reentry and landing device for a rocket stage for the safe reentry of a rocket stage into the atmosphere, and for the safe splashdown of a rocket stage, the device having the following:
a ballute which is configured to be present as folded in a first state and unfolded in a second state, wherein the ballute in the folded state is able to be disposed on a rocket stage so that the aerodynamics of the rocket stage are not compromised by the ballute, and wherein the ballute in the unfolded state substantially shrouds the rocket stage;
a shrouding mechanism which is configured to carry out shrouding of the rocket stage with the ballute;
a filling mechanism which, during reentry into the atmosphere, is configured to fill the ballute in the unfolded state with air or gas from a boundary layer which is created between the plasma formed in front of the surface of the device during the reentry and the surface of the device; and
a control unit which is configured to control the shrouding mechanism and the filling mechanism.

The atmosphere reentry and landing device according to the present invention is suitable for the safe reentry of a rocket stage into the atmosphere; however, this may of course also be the initial entry (rather than a reentry) of a rocket stage or of another body to be returned to a planet (e.g., a capsule, an experiment, a product, etc.). By definition, these cases are also comprised by the scope of protection of the present invention. The body to be returned to the planet usually has a substantially cylindrical shape. The atmosphere reentry and landing device is moreover suitable for the safe splashdown of a rocket stage (or any other body). This means that a rocket stage equipped with the atmosphere reentry and landing device floats in water and does not sink until the device can be recovered.

According to the present invention, the atmosphere reentry and landing device comprises a ballute. The technical term ballute is a portmanteau of the terms balloon and parachute. A ballute is a high-velocity parachute which functions in the subsonic range and in the supersonic range. As opposed to a usual parachute, a ballute possesses a closed area in the front or lower region (in contrast, a normal parachute would be open in these regions). According to the present invention, the balloon is configured to be present as folded in a first state and unfolded in a second state. A folded state herein is understood to be a folded-up or furled state, i.e., in any case a miniaturized state, in which the ballute can be disposed in a space-saving manner. In this space-saving folded state, the ballute is able to be disposed, or is disposed, on a rocket stage (or on any other body) so that the aerodynamics of the rocket stage are not compromised by the ballute. The focus here is predominantly on the aerodynamics of the rocket stage during launch or in flight with the engines turned on. In the folded state, the ballute can, for example, therefore be disposed proximal to the engine and it is advantageous to choose a rotationally symmetrical design of the ballute, or of covers about the rocket body that surround the ballute, respectively. It is, however, also possible for the ballute to be integrated on the inside of the rocket. A special opening can, for example, here be provided. According to the present invention, the ballute in the unfolded state substantially shrouds the rocket stage. This means that substantially the entire rocket stage is shrouded by the ballute and is consequently situated within the ballute. The two outer ends of the ballute, thus the uppermost point and the lowermost point, are spaced apart as far as possible. The ballute here does not yet have to be filled with gas, or be unfolded without creases, respectively. When the rocket stage reenters the atmosphere, the entire rocket stage is thus substantially shrouded or protected by the ballute. Only the engine or engines can, for example, protrude out of the ballute, and/or the rocket tip can, for example, terminate conjointly with an external area of the ballute. Further details in this regard are set forth below.

The present invention provides a shrouding mechanism which is configured to carry out shrouding of the rocket stage with the ballute. This can, for example, be a mechanical or electromechanical shrouding mechanism which can be configured in one part or in multiple parts. Mechanical components can, for example, be used because these can be provided to be very reliable and optionally also redundant. The shrouding of the rocket stage can be carried out via the shrouding mechanism; this means that the ballute can be transferred from the folded state to the unfolded state. The ballute here need not be completely brought into shape; it is rather a matter of pulling apart the two outer ends of the ballute. In this case, pulling-apart of the outer ends of the ballute, and as a result shrouding of the rocket stage, is performed. It is also possible to first expose the ballute via the shrouding mechanism, e.g., to open, jettison or blast off an outer transport casing of the ballute. Pulling-apart of the ballute and the actual shrouding only take place thereafter.

The present invention also provides a filling mechanism which, during reentry into the atmosphere, is configured to fill the ballute in the unfolded state with air (or other gases present in the atmosphere) from a boundary layer which is created between the plasma formed in front of the surface of the device during reentry and the surface of the device. A filling mechanism of this type is advantageous because it is unnecessary to transport an extra pressurized tank or pressurized-gas container onboard into orbit. This reduces the weight of a rocket stage and increases the maximum possible payload. The fact that air from the barrier layer between the plasma and the surface of the atmosphere reentry and landing device can be used for filling the ballute has been established in intensive experiments. The air which exists in this boundary layer is indeed very hot. Combustion of the atmosphere reentry and landing device must therefore be feared when utilizing the air. The present invention accordingly provides that the hot air is only required or used to a very minor extent, and is, for example, sucked into the ballute in a targeted and minutely metered manner. Incineration of the device is thus avoided, and it is much rather possible for the hot air to be utilized. The filling mechanism can again be configured in one part or multiple parts, and will be described in greater detail below.

The present invention provides that the atmosphere reentry and landing device comprises a control unit which is configured to control the shrouding mechanism and the filling mechanism. The control unit can per se be configured in one part or multiple parts; the control unit can, for example, have a CPU, a remote control, a time control and/or similar. The control unit is in particular configured to start the shrouding mechanism at a suitable point in time. The control unit can, for example, also control the speed of shrouding, but this is not mandatory. It is possible that the shrouding mechanism, upon an activating signal, performs the shrouding completely and, for example, at a constant speed, thus transferring the ballute from the folded state to the unfolded state, or pulling apart the ballute at the outer ends thereof, respectively. The filling mechanism can likewise be activated by the control unit, but may also be controlled permanently or intermittently by via the control unit during the flight. It is in particular also possible to regulate the filling mechanism to thereby maintain a pressure in the ballute at a predetermined pressure level (in absolute terms or relative to the ambient pressure).

The rocket stage mentioned is not per se a component part of the atmosphere reentry and landing device. It is, however, possible to design a system having a rocket stage and the atmosphere reentry and landing device. It is moreover possible to retrofit an existing rocket stage with the atmosphere reentry and landing device according to the present invention.

In an embodiment of the present invention, the ballute can, for example, be disposed on a rocket stage so that a rocket engine of the rocket stage during reentry into the atmosphere is disposed at the rear in the direction of flight. The reentry direction of the rocket stage thus differs according to the present invention from the reentry direction according to the prior art cited above. This has the advantage that the rocket engine is better protected during reentry into the atmosphere. In the case of a splashdown, it is possible that the rocket engine be safely kept out of the water and is not immersed therein, thereby preventing corrosion by sea water. It is moreover a fact that a rocket need not undergo a motion reversal prior to unfolding the ballute; this saves fuel and dispenses with one inflight maneuver.

In an embodiment of the present invention, the ballute, in an upper region in terms of the orientation of the ballute when flying through the atmosphere, has a burble fence. The design of the ballute thus corresponds substantially to the already known designs of a ballute (substantially isotensoid). In conventional ballutes, however, air or gas is sucked into the ballute through openings in the ballute per se, for example, below the burble fence. These openings in the ballute per se do not exist in this way according to the present invention because the ballute would incinerate on the edges of the openings during reentry, and in the case of a splashdown of the ballute, water would invade the ballute through the openings. The present invention accordingly provides filling the ballute with air from a boundary layer instead of by way of the described openings in the ballute per se, to which end, for example, a special dimensionally stable main body in which an air inlet can be integrated is disposed on the ballute (see below). The shape of the ballute in the region thereof which is at the front in the direction of flight (i.e., the lower region) can be described substantially by a cone which in the upper region is adjoined by a hemisphere. The burble fence in the form of a torus is provided in the region of the largest diameter between the cone and the hemisphere. Small deviations from the shape described are possible without substantially compromising the flow characteristics of the ballute.

In an embodiment of the present invention, the atmosphere reentry and landing device can, for example, have a dimensionally stable main body having a central cylindrical through-opening, the internal diameter of which is adapted to the external diameter of a rocket stage. The ballute is fastened directly or indirectly to this dimensionally stable main body. The main body, or the atmosphere reentry and landing device, respectively, can be disposed about a rocket stage via the central cylindrical through-opening, this making the intended shrouding of the rocket stage possible in elegant manner. The internal diameter of the cylindrical through-opening being adapted to the external diameter of a rocket stage enables a good closure between the ballute and the rocket stage, but also a stable relative positioning of the atmosphere reentry and landing device and the rocket stage. It is in particular possible for the device according to the present invention to be displaced in a sliding manner across the outer skin of a rocket stage.

In an embodiment of the present invention, the main body on an end side of the cylindrical through-opening can, for example, have a heat-resistant and in particular a flattened head piece about the cylindrical through-opening, to which head piece, in terms of the orientation of the ballute during reentry into the atmosphere, a front end of the ballute is fastened. The ballute can thus be fastened to the main body in a rotationally symmetrical manner, wherein the fastening to the main body is performed directly or indirectly on the head piece so that the periphery of the head piece can terminate conjointly with the ballute. The head piece can here be shaped as a flat plate, for example, which in the center has the cylindrical through-opening, or a hollow cylindrical piece, respectively. An inclination of the head piece in relation to a central axis of the through-opening, or the cylindrical piece (and thus also in relation to a rocket axis), respectively, can be approximately 40° to 50°, for example, approximately 45°. The fastening of the ballute to the head piece can be performed directly or indirectly, indirectly, for example, via a fastening on the cylindrical piece of the main body that forms the cylindrical through-opening. The head piece as a material can, for example, have a combination of a fiber material and a matrix material, for example, SiC/SiC, C/SiC and/or C/C.

In an embodiment of the present invention, in terms of the orientation of the ballute during reentry into the atmosphere, a rear end of the ballute can, for example, be fastenable to a rocket stage. The ballute per se can be configured so as to be rotationally symmetrical about its central axis, or rotationally symmetrical about the rocket stage, respectively. The fastening of the ballute on the rocket stage can, for example, be an encircling fastening. The ballute can, for example, be fastened to a rocket stage so as to be proximal to the engine. The more proximal to the engine the fastening is performed, the more complete the shrouding of the rocket stage with the ballute overall can be performed.

In an embodiment of the present invention, the atmosphere reentry and landing device can, for example, be configured to move the main body from a launching fastening arrangement on a rocket stage externally along the rocket stage to a landing fastening arrangement on the rocket stage. The launching fastening arrangement and the landing fastening arrangement herein denote the respective points or regions at which the main body is disposed externally on the rocket stage, or about this rocket stage, during the launch phase or during the landing phase, respectively. The movement from the launching fastening arrangement to the landing fastening arrangement can, for example, be performed by mechanical traction or thrust, or else be performed electromechanically.

In an embodiment of the present invention, the launching fastening arrangement of the device can, for example, be provided proximal to the engine. Additionally or alternatively, the landing fastening arrangement can be provided proximal to the rocket tip.

In an embodiment of the present invention, the main body, via the shrouding mechanism, can, for example, be movable externally along the rocket stage. The main body can in particular slide along the latter; in the shrouding process of the rocket stage via the ballute, the ballute is disposed fixedly/immovably directly or indirectly on one end of the rocket. The ballute can form a largely air-impermeable closure with the rocket stage, for example, via a clamping mechanism or a tensioning mechanism, but other types of fastening are also possible. One example is a clamping ring which jams or clamps one part of the ballute between the clamping ring and the rocket. The other end of the ballute is in contrast not disposed in a locationally fixed manner on the rocket stage but is connected to the dimensionally stable main body of the device. This dimensionally stable main body can now be displaced along the main axis of the rocket stage. The main body can, for example, be displaced from a launching fastening arrangement which is proximal to the engine to a landing fastening arrangement which is proximal to the rocket tip. Mechanical mechanisms can in particular be used therefor, for example, a winch, a gearwheel system and/or a linear drive. Other mechanisms are, however, also possible, for example, electric or electromechanical mechanisms. It is moreover possible for the system is to be provided as redundant so as to provide an improved reliability. The ballute unfolds as a result of the movement of the main body externally along the rocket stage; it is possible by way of the degree of the movement of the main body along the rocket stage to set how far a part of a rocket stage, in particular a rocket tip, protrudes from the ballute. It is here advantageous for the rocket tip to not protrude from the ballute or to protrude only slightly therefrom. In comparison to the rocket engines, the rocket tip is relatively immune, in particular in terms of corrosion by saltwater and the impact during splashdown.

In an embodiment of the present invention, the atmosphere reentry and landing device can, for example, have a transport cover which covers the ballute during a rocket launch and which is able to be opened or separated. According to one example, this is an external shell that is able to be blasted off. It is also possible, however, for the transport cover to be implemented via a flap mechanism or via a folding mechanism.

In an embodiment of the present invention, the head piece of the dimensionally stable main body of the device can, for example, have a closable air inlet through which the air from the boundary layer can flow into the ballute. The air inlet is here thus not provided in the ballute per se, but in the heat-resistant head piece adjacent to the ballute. The air inlet per se can be implemented in different ways. For example, the air inlet can have one or a plurality of flaps, one or a plurality of lamellae, and/or one or a plurality of bores. Providing a flap here is particularly simple because the opening and closing of a flap can be controlled in a simple manner. The control unit according to the present invention can in turn be used therefor. According to an embodiment of the present invention, the air inlet can, for example, comprise two flaps which are disposed so as to be diametrically opposite one another. It is also possible, however, for more than two flaps, for example, three, four, five or even more flaps, to be provided, and for the flaps to be disposed regularly or irregularly in the head piece.

In an embodiment of the present invention, at least one turbine can, for example, be disposed on the main body so that air flowing in through the air inlet is able to be sucked by the turbine and forced into the ballute so that an overpressure can be created in the ballute in comparison to the ambient pressure. This can, for example, only be a slight positive pressure; this is already sufficient in terms of the dimensional stability and the deceleration behavior of the device according to the present invention. The backpressure acting on the reentry body is composed of the ambient pressure (static pressure) and the dynamic pressure by virtue of the velocity. When reentering the atmosphere, the static pressure is only slightly above the vacuum, whereas the dynamic pressure is comparatively high (the velocity v is a few kilometers per second, for example, approximately 8 km/s). The static pressure during splashdown is in contrast comparatively high while the dynamic pressure is relatively low, the velocity v being only a few meters per second, for example, approximately 10 m/s). In an embodiment of the present invention, the filling mechanism and thus the pressure in the ballute can, for example, be controlled so that the pressure p in the ballute meets the following condition: pstatic+1.1*pdynamic≤p≤pstatic+1.3*pdynamic. The number of turbines can, for example, furthermore be adapted to the number of flaps or different air inlets in the head piece, respectively. The turbine or the turbines can, for example, be controlled via the control unit.

In an embodiment of the present invention, the ballute can, for example, be configured to be high-temperature resistant and to have a low air permeability. The high-temperature resistance is required in order to withstand the high temperatures during the reentry. As opposed to systems already known, it is not mandatorily required that the ballute here be configured to be completely air-impermeable. The ballute may readily have a low air permeability because air or gas can continuously be resupplied via the air inlet, the air or gas being able to be brought to a slight positive pressure via the turbines in the ballute. This is likewise an important advantage compared to solutions from the prior art which resort to pressurized-gas containers because once the gas contained therein has been consumed, it cannot be further replaced. Absolutely air-impermeable embodiments of a ballute are therefore required for solutions according to the prior art.

In an embodiment of the present invention, the ballute can, for example, have a woven ceramic fabric and/or a woven carbon fiber fabric. In an embodiment, the woven ceramic fabric can, for example, comprise silicon carbide which can in particular be coated with zirconium oxide and/or Inconel® so as to reduce the air permeability of the woven silicon carbide fabric.

A second aspect of the present invention provides a system which has the following:
the atmosphere reentry and landing device for a rocket stage for the safe-reentry of a rocket stage into the atmosphere and for the safe splashdown of a rocket stage; and
a rocket stage.

In an embodiment, the rocket stage can, for example, be a lower rocket stage or a booster stage, respectively. In an embodiment of the present invention, the rocket stage can, for example, be an orbital stage. Via the system according to the present invention, it is thus possible for the first time to also safely bring orbital stages back to the earth. The degree of reusability of rockets is thus increased dramatically overall because it was previously not possible to return orbital stages.

In an embodiment of the present invention, in addition to the filling mechanism, which during reentry into the atmosphere is configured to fill the ballute in the unfolded state with air or a gas from a boundary layer which is created between the plasma formed in front of the surface of the device during reentry and the surface of the device, the present invention additionally provides a further filling mechanism which is configured to fill the ballute with gas, in particular oxygen, from a rocket tank so as to initially bring the ballute into shape prior to reentry into the atmosphere. A rocket carries on board liquid oxygen as an oxidant anyway, and the associated tank for structural reasons is pressurized to a positive pressure of approximately two to three bar. This gas can be easily discharged to the outside via a valve, for example, after the burnout of the rocket and after shrouding of the rocket with the ballute. The gas makes its way directly into the ballute for initial inflation, the ballute then already shrouding the rocket stage. This embodiment also provides that the carrying of additional pressurized containers on board can be dispensed with, specifically even when it is desirable for the ballute to be initially brought into shape even before the reentry commences.

A third aspect of the present invention provides a method for the reentry of a rocket stage into the atmosphere, in particular while using the atmosphere reentry and landing device as described above, the method comprising the following steps:
shrouding the rocket stage with a ballute prior to reentry so that a reentry body is formed; and
filling the ballute with air from a boundary layer which is created between a plasma formed during reentry and the (colder) surface of the reentry body.

In an embodiment of the present invention, the method can, for example, also comprises the following step: generating a positive pressure in the ballute.

It can be avoided as a result that the ballute must be embodied so as to be absolutely air-impermeable, this in turn having a positive effect on the consumption of material for the ballute and thus also on the mass of the ballute.

In an embodiment, the method can, for example, further comprise the following step: splashdown of the rocket stage with the rocket tip ahead. The rocket tip is significantly less sensitive than the rocket engines, which is why this reentry orientation or splashdown orientation can be used.

The statements made in the context of the first and the second aspect of the present invention otherwise also apply to the third aspect of the present invention.

A fourth aspect of the present invention provides an atmosphere entry and landing device for a body for the safe entry into the atmosphere and for the safe splashdown, the device having the following:
a transport region which is configured to receive a body during transport;
a ballute which is configured to be present as folded in a first state and unfolded in a second state, and in the second state to substantially shroud the device from the outside;
a shrouding mechanism which is configured to carry out the shrouding with the ballute;
a filling mechanism which, during entry into the atmosphere, is configured to fill the ballute in the unfolded state with air or gas from a boundary layer which is created between the plasma formed in front of the surface of the device during entry and the surface of the device; and
a control unit which is configured to control the shrouding mechanism and the filling mechanism.

According to this aspect of the present invention, basic concepts of the present invention are applied to the general case which is not focused especially on the return of rocket stages and also not on the return of other specially shaped bodies. According to this embodiment, arbitrary bodies can instead be in principle transported (back) to the planet surface by way of the atmosphere (re)entry and landing device. For this purpose, the device has the transport region which is configured to receive the body during transport. The body can thus be fastened thereto and/or be completely enclosed by the transport region. This depends on the size, the shape, and also on the material characteristics of the body. In any case, the body for entry into the atmosphere is substantially completely shrouded by the ballute and thus protected thereby. It is conceivable, for example, for a transport region in the inner region of the cylindrical piece to be provided as a transport region, as described in the context of the first aspect of the present invention, or for a transport region in the inner region of the cylindrical piece to be redesigned as such a transport region. The shape of the transport region here need of course not be or remain cylindrical, respectively, but this may be the case. As in the first aspect of the present invention, the device can have a plate-like head piece, and the ballute can be fastened thereto directly or indirectly in the way described. It is, however, advantageous for the plate-like head piece not to have a central opening because the device does not have to be moved across the surface of a rocket stage in order to shroud the rocket stage. The atmosphere entry and landing device according to the fourth aspect can as a result therefore have a more compact configuration. The filling mechanism is identically configured as described in detail in the context of the first aspect of the present invention. The shrouding mechanism can, but does not have to be, simplified and can be implemented, for example, only by opening or blasting of a transport cover so that the ballute is released and ready for filling.

A fifth aspect of the present invention provides a method for the entry of a body into the atmosphere, in particular while using the atmosphere entry and landing device as described according to the fourth aspect of the present invention, the method comprising the following steps:
shrouding the body with a ballute prior to entering the atmosphere so that a reentry body is formed; and
filling the ballute with air from a boundary layer which is created between a plasma formed during entry into the atmosphere and the surface of the atmosphere entry body.

The filling of the ballute can, for example, here take place by a controlled suction of the air, for example, via turbines. The air is in particular furthermore accumulated in the ballute; the ballute has no openings which cannot be closed. What has already been stated in the context of the fourth aspect of the present invention otherwise also applies in principle to this embodiment.

A sixth aspect of the present invention provides a method for filling a ballute during entry into the atmosphere, the method comprising the following steps:
filling the ballute with air from a boundary layer which is created between a plasma formed during entry into the atmosphere and the surface of the atmosphere entry body, wherein the air is sucked in a controlled manner, through an air inlet in the atmosphere entry body, inwards into the ballute, and is in particular accumulated in the ballute.

A positive pressure in relation to the ambient pressure can be built up in the ballute as a result of the accumulation. The controlled suction and the substantially tight embodiment of the ballute make it possible for the ballute to be brought into shape and to be kept in shape with only a small amount of air. It is therefore possible for the hot air from the boundary layer to be utilized therefor without the ballute or the cargo shrouded by the latter being incinerated when entering the atmosphere.

The embodiments of the present invention described can be partially or completely combined with one another unless technical conflicts result therefrom.

The present invention will be even better understood with reference to the appended drawings which are described below.

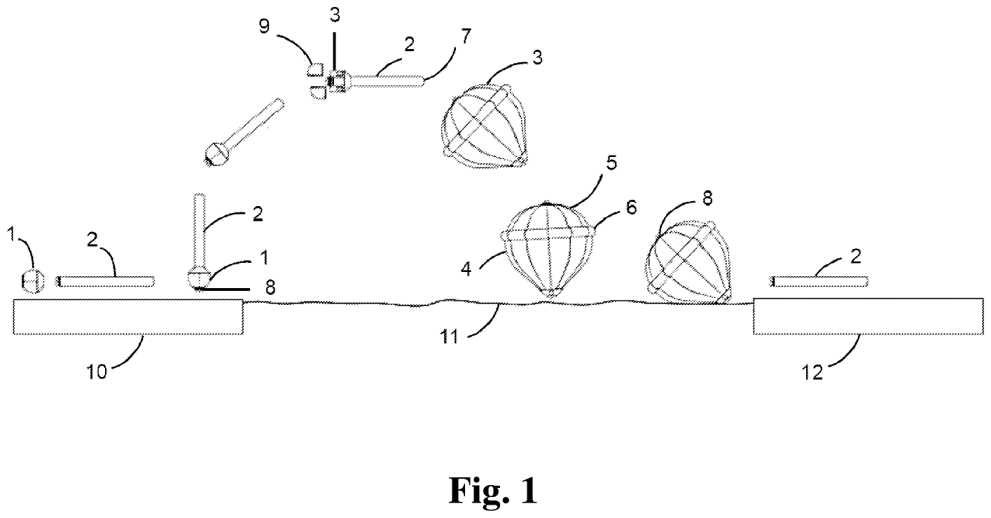

FIG. 1 schematically illustrates a launch and reentry of the atmosphere reentry and landing device according to the present invention into the atmosphere with subsequent splashdown. Essential aspects of the present invention can already be highlighted via the illustration shown in FIG. 1. The atmosphere reentry and landing device 1 according to the present invention can also be retrofitted to existing rocket stages 2, i.e., the atmosphere reentry and landing device 1 is conceived for a wide range of applications. The atmosphere reentry and landing device 1 is suitable for different rocket types and in particular for large and small rocket stages. In the schematic illustration in FIG. 1, the system of atmosphere reentry and landing device 1 and rocket stage 2 is assembled to form an overall system in the launch zone 10. Subsequently, the rocket stage 2 conjointly with the atmosphere reentry and landing device 1 is brought to the launch position. The atmosphere reentry and landing device 1 here is disposed in the lower region of the rocket stage 2, proximal to the engines 8. The atmosphere reentry and landing device 1 encloses the rocket stage 2 in a substantially rotationally symmetrical manner and has no substantial negative influence on the aerodynamic flight characteristics of the rocket stage 2.

Once the rocket stage 2 has reached the desired altitude/the desired orbit, the shrouding mechanism is activated or controlled via a control unit. In the shown example, a transport cover 9 in the present example is first blasted off and the ballute 3 lying under the transport cover 9 is exposed. The ballute 3 is then transferred from its folded state to its unfolded state via the shrouding mechanism, and the ballute 3 substantially shrouds the sinking rocket stage 2 in the process. Specifically, one end of the ballute 3 is pulled from the engine-proximal end of the rocket stage 2 to the rocket tip-proximal end of the rocket stage 2 so that the rocket stage 2 is substantially shrouded. In the process, the opposite end of the ballute 3 is firmly held, or is firmly fixed to the rocket stage 2, respectively. The tip 7 of the rocket stage 2 is therefore oriented towards the front, or downwards, respectively, when re-entering the earth atmosphere, while the engine 8 is oriented towards the rear or the top, respectively. The ballute 3 in the lower region 4 is substantially conical, while the ballute in the upper region 5 has substantially the shape of a hemisphere, and a stall ring/burble fence 6 is situated at the location with the largest diameter. The task of the stall ring/burble fence 6 is to stall the air stream in a targeted manner at this location. The ballute 3 is thereby stabilized in the atmosphere at supersonic speed and at subsonic speed. While flying through the atmosphere, the ballute 3 finally attains a velocity limit and then impacts the water 11 with the tip 7 ahead. The rocket engines 8, which are sensitive to salt water, protrude from the water 11 and are thus protected in the process. The rocket stage 2 can subsequently be recovered and be refurbished for reuse at a refurbishment site 12.

The process illustrated in FIG. 1 can be carried out for booster stages as well as for orbital stages of rockets. It is also possible to use the atmosphere reentry and landing device 1 according to the present invention as a rescue device in the event of an aborted launch in that, from an altitude of approximately 2 km to 3 km above the surface of the earth, sufficient time exists for the ballute 3 to unfold and thus for safe landing.

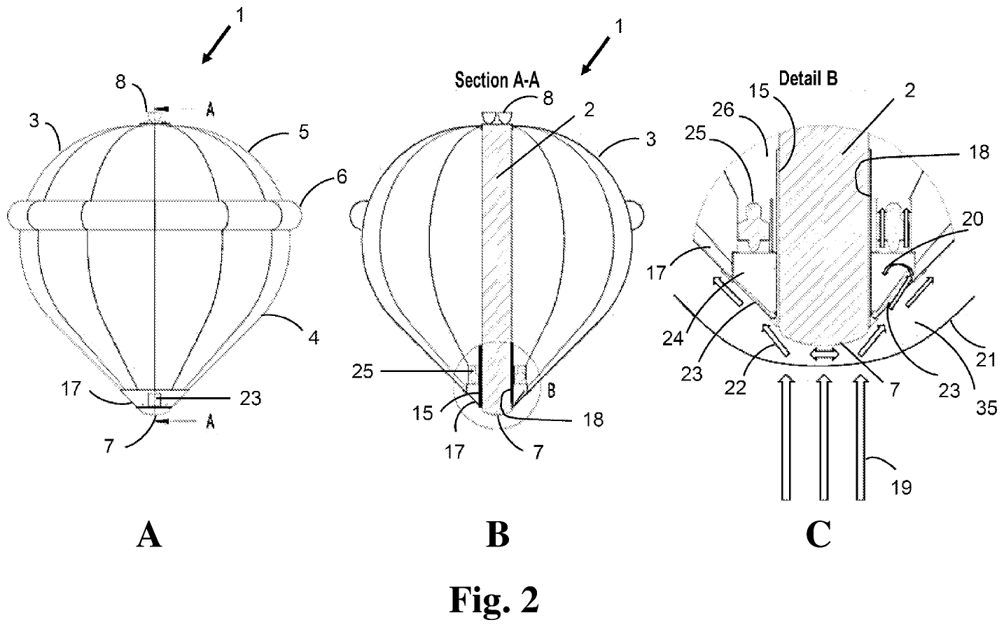

FIG. 2 schematically illustrates an atmosphere reentry and landing device 1 in a plurality of views, including a filling mechanism for the ballute 3 with air from a boundary layer between the plasma and the surface of the reentry body. FIG. 2A illustrates a lateral view of the atmosphere reentry and landing device 1 according to the present invention with a ballute 3. The ballute 3 is thereby illustrated in the unfolded state. The ballute 3 here substantially shrouds the rocket stage 2. Only the engines 8 of the rocket stage 2 here protrude beyond the ballute 3; in the example shown, the tip 7 of the rocket stage 8 terminates so as to be flush with the surface of the plate-like head piece 17 of the atmosphere reentry and landing device 1. It would also be possible, however, that the tip 7 of the rocket stage 8 protrudes somewhat more from the atmosphere reentry and landing device 1 according to the present invention, a degree of protrusion/projection being in particular adjustable. FIG. 2A illustrates substantially the shape of the ballute 3 and the appendage of the plate-like head piece 17 to the ballute 3 in the region of the tip 7 of the rocket stage 2. The upper region 5 of the ballute 3 has substantially the shape of a hemisphere, the lower region 4 being of a substantially conical configuration. The stall ring/burble fence 6 is disposed in the region of the largest diameter. The specific design of the ballute 3 may differ from the design described by way of example as long as the aerodynamic properties of the atmosphere reentry and landing device 1 remain substantially unchanged and/or the inflight behavior remains stable. The plate-like head piece 17 of the main body 15 of the atmosphere reentry and landing device 1 in the example shown possesses two flaps 23, one of which is visible in FIG. 2A. The air supply to the ballute 3 takes place through these flaps 23.

FIG. 2 B shows a section along the line A-A which is plotted in FIG. 2A; FIG. 2 C shows a detail B from FIG. 2 B. The rocket stage 2 with its tip 7 and its engines 8 can be seen in the interior of the atmosphere reentry and landing device 1 according to the present invention. The main body 15 of the atmosphere reentry and landing device 1 is disposed about the rocket tip-proximal region of the rocket stage 2. The main body 15 possesses a central cylindrical through-opening 18, the internal diameter thereof being adapted to the external diameter D of the rocket stage 2. Next to a cylindrical piece 16, the main body 15 comprises a heat-resistant and in particular flattened plate-like head piece 17 to which the front end 4 of the ballute 3 is fastened. The upper region 5 of the ballute 3 is fastened so as to be proximal to the 8 engines on the rocket stage 2.

When reentering the earth atmosphere (or any other planet's atmosphere), a plasma is formed in front of the reentry body formed by the tip 7 of the rocket stage 8, the plate-like head piece 17 and the ballute 3. The plate-like head piece 17 as well as the ballute 3 are configured in a correspondingly heat-resistant manner. In the example illustrated, the ballute 3 has a woven ceramic fabric; for example, the ballute 3 comprises a woven silicon carbide fabric which is coated with zirconium oxide and/or Inconel®. The coating serves to reduce the air permeability of the woven silicon carbide fabric. A reduction is sufficient; a complete closure in relation to air (gas) is not necessary because the ballute 3 in the unfolded state is continually fed fresh air (gas) from a boundary layer between the plasma and the surface of the reentry body.

This air supply is illustrated in more detail in FIG. 2 C. A hypersonic airstream 19 impacts the reentry body, and a shock wave 21 is created. A boundary layer 35 in which an airstream 22 is formed is created between the somewhat cooler surface of the reentry body (tip 7, plate-like head piece 17, and adjacent surface of the ballute 3) and the plasma created in front thereof. This airstream 22 can flow into the atmosphere reentry and landing device 1 according to the present invention through the flaps 23. The inflowing air is a subsonic airstream 20. For illustrative purposes, a closed flap 23 is illustrated on the left, and an opened flap 23 is illustrated on the right in FIG. 2 C. Opening and closing of the flaps 23 can be controlled via the control unit 33 according to the present invention, in particular also passively by actuating the turbines 25 (suction of air from the boundary layer). In this instance, a spring mechanism can, for example, be used for closing/resetting the flaps 23. Two flaps 23 are provided in the example shown; but only one flap 23 or more than two flaps 23, for example three, four, five or more flaps 23, may also be provided. It is also possible for the flaps 23 to be replaced or supplemented by other air inlets. The inflowing subsonic air 20 in the example shown first enters two chambers 24, one turbine 25 being disposed at the end of each thereof. Air flowing in through the flaps 23 can be sucked by the turbine 25 and forced into the ballute 3 so that a positive pressure can be created in the ballute 3 in comparison to the ambient pressure. The degree of this positive pressure can, for example, be adjusted via the control unit 33 according to the present invention.

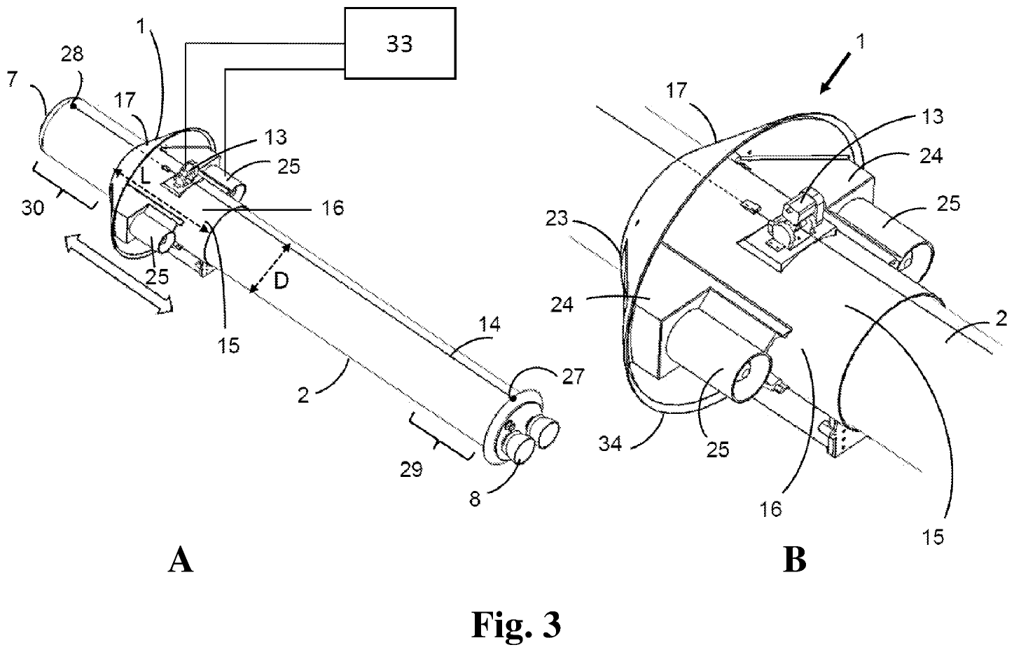

FIG. 3 schematically illustrates a shrouding mechanism according to the present invention. For reasons of simplification, the ballute 3 is not included in the illustration. FIG. 3 A shows the entire rocket stage 2 with the tip 7 and the engine 8. FIG. 3 B shows an enlarged fragment in which details of the atmosphere reentry and landing device 1 according to the present invention in greater detail. In the example shown, the shrouding mechanism is implemented via a winch 13 and via a wire rope 14, wherein the wire rope 14 has an engine-proximal fastening point 27 and a rocket tip-proximal fastening point 28. The atmosphere reentry and landing device 1 can be displaced along the rocket stage 2 via the winch 13, the winch 13 being controllable by the control unit 33. It is specifically possible for the atmosphere reentry and landing device 1 to be displaced from a launching fastening arrangement 29 to a landing fastening arrangement 30. The movement herein is indicated by the double arrow in FIG. 3A. A gearwheel system and/or a linear drive might also be used instead of the winch 13, and other variants of embodiment are also possible. It is also possible for the system shown to be provided as redundant, i.e., twice or generally in multiples. This provides higher reliability, where purely mechanical systems have a very high reliability from the outset.

The external shape of the atmosphere reentry and landing device 1 (with the exception of the ballute 3 not being illustrated) can also be readily seen in FIG. 3 B. The atmosphere reentry and landing device 1 comprises a main body 15 which is dimensionally stable and in the example shown has a cylindrical piece 16 and a plate-like head piece 17. The cylindrical piece 16 here, in the manner of a sleeve, encloses a portion of the rocket stage 2. The cylindrical through-opening 18, the internal diameter thereof being adapted to the external diameter of the rocket stage 2, is provided inside the cylindrical piece 16. The atmosphere reentry and landing device 1 according to the present invention, or the main body 15 thereof, can thereby slide externally along the rocket stage 2, respectively. The length L of the cylindrical piece 16 can here be approximately one third of the internal diameter D of the cylindrical through-opening 18. The angle α of the plate-like head piece 17 in relation to the axis of the cylindrical through-opening 18 in the example shown is approximately 45°. Other specific values are, however, also possible in each case.

In the example shown, two turbines 25 are disposed on the main piece 15, the axial direction of the turbines 25 running parallel to the axial direction of the rocket stage 2. In terms of the axial direction, one flap 23 is in each case disposed in front of the turbine 25, air emanating from the formed boundary layer being able to enter the ballute 3 (not illustrated) through the flaps 23 and the turbines 25.

The control unit 33 according to the present invention is moreover schematically illustrated in FIG. 3A. The control unit 33 is configured to (actively or passively) actuate the shrouding mechanism, here specifically, the winch 13, as well as the filling mechanism, here specifically, the turbines 25 and the flaps 23. Other variants of embodiment are also possible. The control unit 33 can moreover be configured to also open or remove the transport cover 9 (see FIG. 1), for example, to blast off the transport cover 9. The control unit 33 can moreover be integrated in a rocket control unit, but may also be provided as a separate control unit.

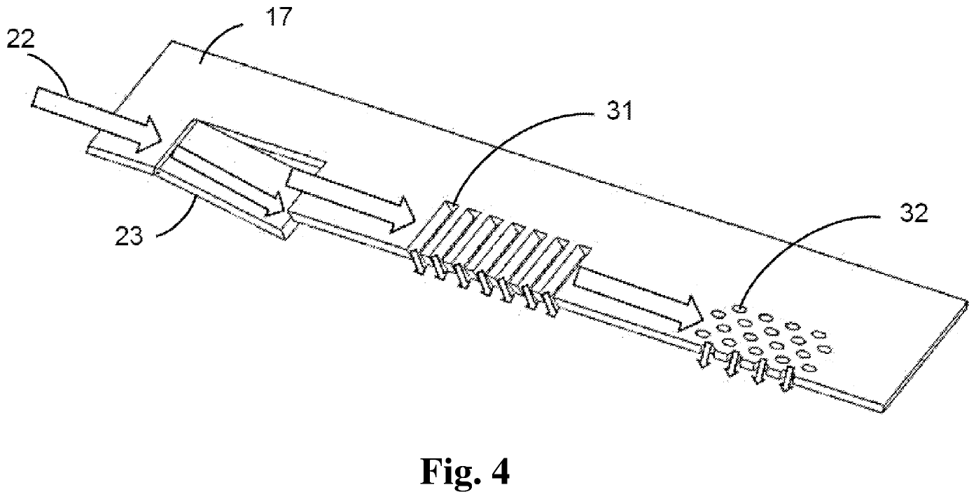

FIG. 4 illustrates different types of air inlets for a filling mechanism in a schematic illustration. In the example shown, only a fragment of the plate-like head piece 17 of the atmosphere reentry and landing device 1 according to the present invention is shown. This plate-like head piece 17 in the example illustrated has a flap 23, a plurality of lamellae 31, and a plurality of bores or holes 32 through which an airstream 22 emanating from the boundary layer 35 can enter the ballute 3, or enter towards the turbines 25 and the chambers 24. The air inlets (i.e., the flaps 23, lamella 31, and bores or holes 32) are here controllable, i.e., they can be opened or closed as required. This is of course very easy to implement for the flaps 23 illustrated. There are, however, possible solutions known in principle also for the lamellae 31 and the bores or holes 32. In one example, the air inlets 23, 31, 32 are passively opened by the operation of the turbines 25 (suction). When the turbines 25 are switched off (again), a spring mechanism for resetting or closing the air inlets 23, 31, 32 can, for example, be used. It is also possible, however, for the air inlets 23, 31, 32 to be hydraulically or electromechanically controlled.

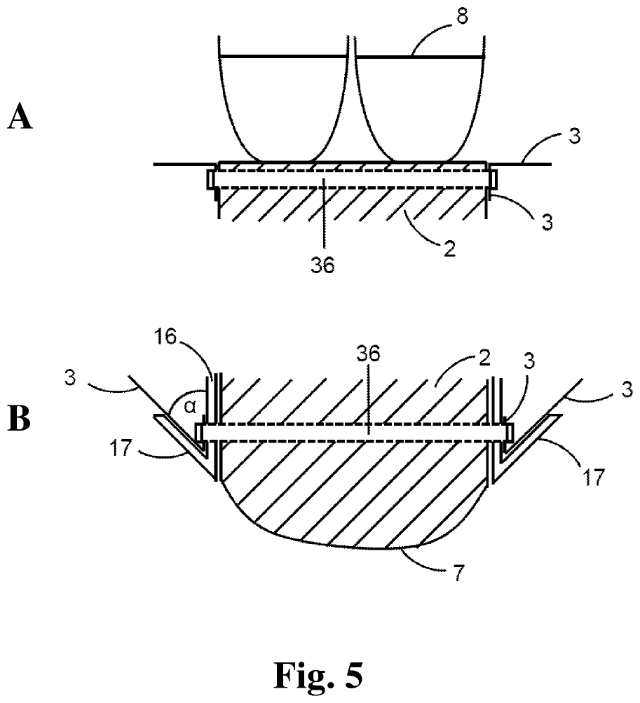

FIG. 5 schematically illustrates fastenings of a ballute 3. FIG. 5A shows a fastening of the ballute 3 proximal to the engine 8. Provided in the example shown is a clamping ring 36. The ballute 3 is firmly clamped or jammed between the clamping ring 36 and the rocket stage 2, or the surface of the rocket, respectively. The ballute 3 could alternatively also be adhesively bonded or fastened in another way. The fastening illustrated provides a largely air-impermeable closure in the engine-proximal region between the ballute 3 and the rocket stage 2 shrouded by the ballute 3. FIG. 5 B shows a fastening of the ballute 3 to the main body 15 with the cylindrical piece 16 and the plate-like head piece 17. In the example shown, a clamping ring 36 which clamps or jams the ballute 3 between the cylindrical piece 16 and the clamping ring 36 in a largely air-impermeable manner is here also used. No direct fastening of the ballute 3 to the plate-like head piece 17 is provided in the example shown; instead, the fastening of the ballute 3 to the plate-like head piece 17 is an indirect fastening. Within the main body 15, the ballute 3 is only folded back or folded over and fits snugly on the inner periphery of the plate-like head piece 17. It is, however, also additionally or alternatively possible for the ballute 3 to be fastened directly to the plate-like head piece 17, for example, to be adhesively bonded from the inside or the outside. An angle between the plate-like head piece 17 and the cylindrical piece 16 (or with the axis of the cylindrical through-opening 18) in the example illustrated is approximately 45°.

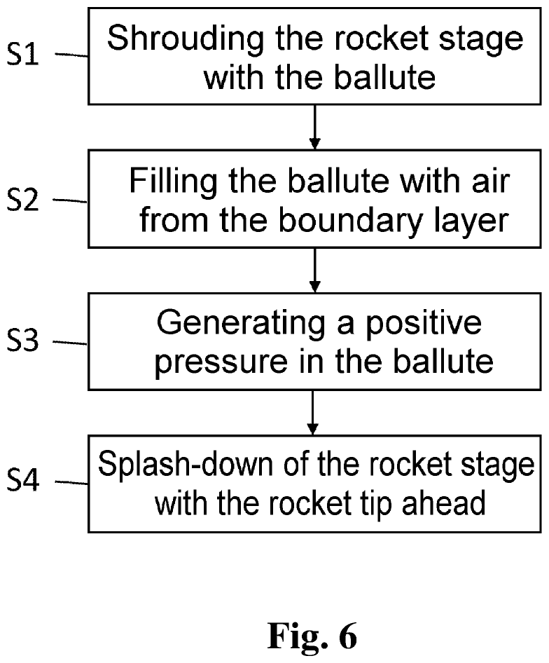

FIG. 6 shows a flow chart of a method according to the present invention for the reentry of a rocket stage 2 into the atmosphere. It is here assumed that the rocket stage 2 has already been launched and has burnt out, or that the body which is to re-enter is already in orbit. To this extent, the method commences with the method step 51, which comprises shrouding the rocket stage 2 with a ballute 3 prior to reentry so that a reentry body is formed. In a method step S2, filling of the ballute 3 with air (or any other gas) from a boundary layer which is created between a plasma formed during reentry and the surface of the reentry body is then performed. The method can be carried out, but need not be carried out, with the atmosphere reentry and atmosphere reentry landing device 1 according to the present invention described above.

In a further optional method step S3, generating a positive pressure in the ballute 3 is performed. It is thus not necessary for the ballute 3 to be designed so as to be completely air-impermeable because topping-up with air or gas can always take place. It is also not necessary for heavy pressurized-gas containers to be integrated in the rocket or the atmosphere reentry and landing device 1.

In a further method step S4, a splashdown of the rocket stage 2 with the tip 7 of the rocket stage 8 ahead is performed. The sensitive engines 8 of the rocket stage 2 are thereby protected against water or saltwater, respectively.

The atmosphere reentry and landing device according to the present invention and the method according to the present invention for the first time permit the successful reuse of not only booster stages but also of orbital stages of rockets. The atmosphere reentry and landing device and the method are able to be used for all rocket types, and in particular also for small rockets.

The present invention is not limited to embodiments described herein; reference should be had to the appended claims.

### LIST OF REFERENCE SIGNS

1 Atmosphere reentry and landing device
2 Rocket stage
3 Ballute
4 Lower region of the ballute
5 Upper region of the ballute
6 Stall ring/Burble fence
7 Tip (of the rocket stage)
8 Engine (of the rocket stage)
9 Transport cover
10 Launch zone
11 Water
12 Refurbishment site
13 Winch
14 Wire rope
15 Main body
16 Cylindrical piece
17 Plate-like head piece
18 Cylindrical through-opening
19 Hypersonic airstream
20 Subsonic airstream
21 Shock wave
22 Airstream
23 Flap/Air inlet
24 Chamber
25 Turbine
26 Interior space of the ballute
27 Engine-proximal fastening point
28 Rocket tip-proximal fastening point
29 Launching fastening arrangement
30 Landing fastening arrangement
31 Lamella/Air inlet
32 Bore/Hole/Air inlet
33 Control unit
34 Periphery of the plate-like head piece
35 Boundary layer
36 Clamping ring
L Length of the cylindrical piece in the axial direction
D Internal diameter of the cylindrical through-opening/External diameter of the rocket stage
α Angle of the plate-like head piece in relation to the axis of the cylindrical through-opening

What is claimed is:

1-27. (canceled)

28. An atmosphere reentry and landing device for a rocket stage for a safe reentry of the rocket stage into an atmosphere and for a safe splashdown of the rocket stage, the atmosphere reentry and landing device comprising:
a ballute which is configured to be folded in a first state and to be unfolded in a second state, wherein,
in the first state where the ballute is folded, the ballute is configured to be disposed on the rocket stage so that an aerodynamics of the rocket stage is not compromised by the ballute, and
in the second state where the ballute is unfolded, the ballute is configured to substantially shroud the rocket stage;
a shrouding mechanism which is configured to carry out a shrouding of the rocket stage with the ballute;
a filling mechanism which, during a reentry into the atmosphere, is configured to fill the ballute in the second state where the ballute is unfolded with air or a gas from a boundary layer which is created between a plasma formed in front of a surface of the atmosphere reentry and landing device during the reentry and the surface of the atmosphere reentry and landing device; and
a control unit which is configured to control the shrouding mechanism and the filling mechanism.

29. The atmosphere reentry and landing device as recited in claim 28, wherein,
the ballute comprises a rear and an upper region when viewed in a direction of flight through the atmosphere, and at least one of,
the ballute is further configured to be disposed on the rocket stage so that a rocket engine of the rocket stage, during the reentry into the atmosphere, is disposed at the rear of the ballute, and
the upper region of the ballute comprises a burble fence.

30. The atmosphere reentry and landing device as recited in claim 28, further comprising:
a main body which is configured to be dimensionally stable, the main body comprising a central cylindrical through-opening, an internal diameter of the central cylindrical through-opening being adapted to an external diameter of the rocket stage.

31. The atmosphere reentry and landing device as recited in claim 30, wherein,
the main body comprises a head piece which is arranged on an end side of the cylindrical through-opening around the cylindrical through-opening, the head piece being provided so as to be heat-resistant, and
a front end of the ballute, in terms of an orientation of the ballute during the reentry into the atmosphere, is fastened to the head piece.

32. The atmosphere reentry and landing device as recited in claim 31, wherein the head piece comprises an air inlet which is configured to be closable so that air from the boundary layer is flowable therethrough into the ballute.

33. The atmosphere reentry and landing device as recited in claim 32, wherein the air inlet comprises at least one of a flap, lamellae, and bores.

34. The atmosphere reentry and landing device as recited in claim 32, further comprising:
at least one turbine which is arranged on the main body, the at least one turbine being configured so that the air flowing through the air inlet can be sucked by the turbine and forced into the ballute so as to create an overpressure in the ballute compared to the ambient pressure.

35. The atmosphere reentry and landing device as recited in claim 30, wherein the ballute is further configured so that a rear end of the ballute, in terms of an orientation of the ballute during the reentry into the atmosphere, is fastenable to the rocket stage.

36. The atmosphere reentry and landing device as recited in claim 30, wherein,
the rocket stage comprises a launching fastening arrangement and a landing fastening arrangement, and
the atmosphere reentry and landing device is configured to move the main body from the launching fastening arrangement on the rocket stage externally along the rocket stage to the landing fastening arrangement on the rocket stage.

37. The atmosphere reentry and landing device as recited in claim 36, wherein at least one of,
the launching fastening arrangement is proximal to a rocket engine of the rocket stage, and
the landing fastening arrangement is proximal to a tip of the rocket stage.

38. The atmosphere reentry and landing device as recited in claim 37, wherein the main body is configured to be movable externally along the rocket stage via the shrouding mechanism.

39. The atmosphere reentry and landing device as recited in claim 38, wherein the shrouding mechanism comprises at least one of a winch, a gearwheel system, and a linear drive.

40. The atmosphere reentry and landing device as recited in claim 28, further comprising:
a transport cover which is configured to cover the ballute during a rocket launch and to be opened or separated off.

41. The atmosphere reentry and landing device as recited in claim 28, wherein at least one of,
the ballute is configured to be resistant to a high temperature and to have a low air permeability, and
the ballute comprises at least one of a woven ceramic fabric and a woven carbon fibre fabric.

42. A system comprising:
the atmosphere reentry and landing device for as recited in claim 28; and
a rocket stage.

43. The system as recited in claim 42, wherein,
the rocket stage is a booster stage, or
the rocket stage is an orbital stage.

44. The system as recited in claim 42, wherein the atmosphere reentry and landing device further comprises, in addition to the filling mechanism, a further filling mechanism which is configured to fill the ballute with a gas from a rocket tank so as to initially bring the ballute into a shape prior to the reentry into the atmosphere.

45. A method for a reentry of a rocket stage into an atmosphere, the method comprising:
shrouding the rocket stage with a ballute prior to the reentry so as to form a reentry body; and
filling the ballute with air from a boundary layer which is created between a plasma formed during the reentry and a surface of the reentry body.

46. The method as recited in claim 45, further comprising:
generating a positive pressure in the ballute.

47. The method as recited in claim 46, further comprising:
splashdown of the rocket stage with a tip of the rocket state being ahead.

48. An atmosphere entry and landing device for a body for a safe entry into an atmosphere and for a safe splashdown, the atmosphere entry and landing device comprising:
a transport region which is configured to receive a body during a transport;
a ballute which is configured to be folded in a first state and to be unfolded in a second state, wherein, in the second state where the ballute is unfolded, the ballute is configured to substantially shroud the atmosphere entry and landing device from an outside;
a shrouding mechanism which is configured to carry out the shrouding with the ballute;
a filling mechanism which, during entry into the atmosphere, is configured to fill the ballute in the second state where the ballute is unfolded with air or a gas from a boundary layer which is created between the a plasma formed in front of a surface of the atmosphere reentry and landing device during entry and the surface of the atmosphere reentry and landing device; and
a control unit which is configured to control the shrouding mechanism and the filling mechanism.

49. A method for the entry of a body into an atmosphere, the method comprising:
shrouding the body with a ballute prior to entering the atmosphere so as to form an atmosphere reentry body; and
filling the ballute with air from the boundary layer which is created between the plasma formed during entry into the atmosphere and the surface of the atmosphere entry body.

50. A method for the filling of a ballute during an entry into an atmosphere, the method comprising:
filling the ballute with air from a boundary layer which is created between a plasma formed during an entry into the atmosphere and a surface of an atmosphere entry body,
wherein,
the air is sucked in a controlled manner, through an air inlet in the atmosphere entry body, inwards into the ballute, and is accumulated in the ballute.
